(19) United States
(12) Patent Application Publication
(10) Pub. No.: US 2019/0213691 A1
(43) Pub. Date: Jul. 11, 2019

(54) FORESTRY MACHINERY OPERATION METHOD AND OPERATION PROCESSOR PERFORMING METHOD

(71) Applicant: DEERE & COMPANY, Moline, IL (US)

(72) Inventors: JOHANNES KAARNAMETSÄ, TAMPERE (FI); AKI PUTKONEN, TAMPERE (FI); Vesa Siltanen, TAMPERE (FI)

(21) Appl. No.: 16/227,841

(22) Filed: Dec. 20, 2018

(30) Foreign Application Priority Data
Nov. 22, 2017 (EP) 17203131.2

(51) Int. Cl. G06Q 50/02; A01G 23/083; A01G 23/099; G06Q 10/06; G06Q 10/04; G06Q 10/08

(52) U.S. Cl. CPC G06Q 50/02; A01G 23/083; A01G 23/099; G06Q 10/087; G06Q 10/06312; G06Q 10/047; G06Q 10/0637

(57) ABSTRACT

A method for operating forestry machinery includes providing timber units with forestry machines and an operation processor. The method also includes detecting or receiving data from an information source, where the data includes worksite preparation data, navigation data, or worksite situation data. The data is processed by the operation processor and operation parameters of the forestry machine are set based on the processing of the data. The method further includes communicating instructions to the forestry machine by the operation processor, where the instructions include the operation parameters.

### RELATED APPLICATIONS

This application claims priority to German Patent Application Ser. No. 17203131.2, filed Nov. 22, 2017, the disclosure of which is hereby incorporated by reference in its entirety.

### FIELD OF THE DISCLOSURE

The present disclosure relates to a forestry machinery operation method and to an operation processor performing the method.

### BACKGROUND

Harvesting, transporting and processing trees and logs is influenced by a plurality of factors. These factors may be anticipated, however, since they are known from a worksite and the work paths, or may become known during the machinery operation only.

With that said, there is a need to optimize the operation of the machines involved.

### SUMMARY

In a first embodiment of the present disclosure, teaching optimization can be reached at different levels. In fleets, for example, the best suitable machines are selected or equipment is set or selected to meet the anticipated demands. Accordingly, forestry machines of a certain power level, transmission, wheel or track composition, size of a boom or harvester head are selected or in a fleet, and in particular an autonomous fleet, are sent to operation. Navigation data enables one to consider the steepness of a track, the maximum size and load permissibility of a bridge to be passed, and the height under a bridge when forestry machines and equipment is selected or set. Worksite situation data do the fine tuning and adjustments to the local situation which, for example, may find muddy ground, although the weather forecast predicts dry ground. All of this information is used to prepare the machines before a situation is recognized late and an operation cannot be performed, or at least may be performed at a poor level.

Forestry, terrain and soil data are known from sources like drones, satellites, forest officers, long term growth data, visual data from machines which operated on a worksite earlier, LIDAR data, etc. If, for example, it has been observed that trees to be harvested on average are small or thick, a harvester head capacity, boom lift capacity, or saw power capacity can be predicted and a machine can be sent to the forest ready to work as opposed to the use of a wrong harvester head or a too light or heavy machine. At the same time, an over performing machine and related fuel consumption can be avoided as well.

A tree with an abnormally thick branch may cause damage on a head or heat up hydraulic oil if knives are not closed enough or valves are not set properly. Worksite situation data provide for the right setting before such a thick branch is hit. In case of thin branches, knives may be more open and hydraulic pressure will be lower, both reducing power and fuel consumption. Navigation data may help in identifying areas in the forest with certain branch types, like in dark or light portions of the forest.

Not only power related settings may be impacted, but also production settings including the length of the logs to be cut may be fixed and adjusted depending on expectations at a certain area and findings in the actual situation. Moreover, portions of a tree, like bends, many branches, Y-sections, etc., may be used to adjust the production settings.

In order to avoid stalling an engine or wheels/tracks spinning on the ground, navigation data, worksite preparation data from weather forecast and worksite situation data about ground conditions may be used to increase or decrease engine or vehicle speed such that a hill can be mastered by the forestry machine without a problem, without excessive wear at the wheels or tracks, and at optimized fuel consumption.

It depends on the operator, forest owner, weather conditions, environmental demands, etc. which of quality, quantity, wear, etc. will receive priority when operating the machine. This prioritization may change during the operation and may not be limited to one criteria only.

### BRIEF DESCRIPTION OF THE DRAWINGS

The above-mentioned aspects of the present disclosure and the manner of obtaining them will become more apparent and the disclosure itself will be better understood by reference to the following description of the embodiments of the disclosure, taken in conjunction with the accompanying drawings, wherein:

FIG. 1 is a schematic of a worksite in a forest; and

FIG. 2 is a diagram illustrating the interrelation of data and signals.

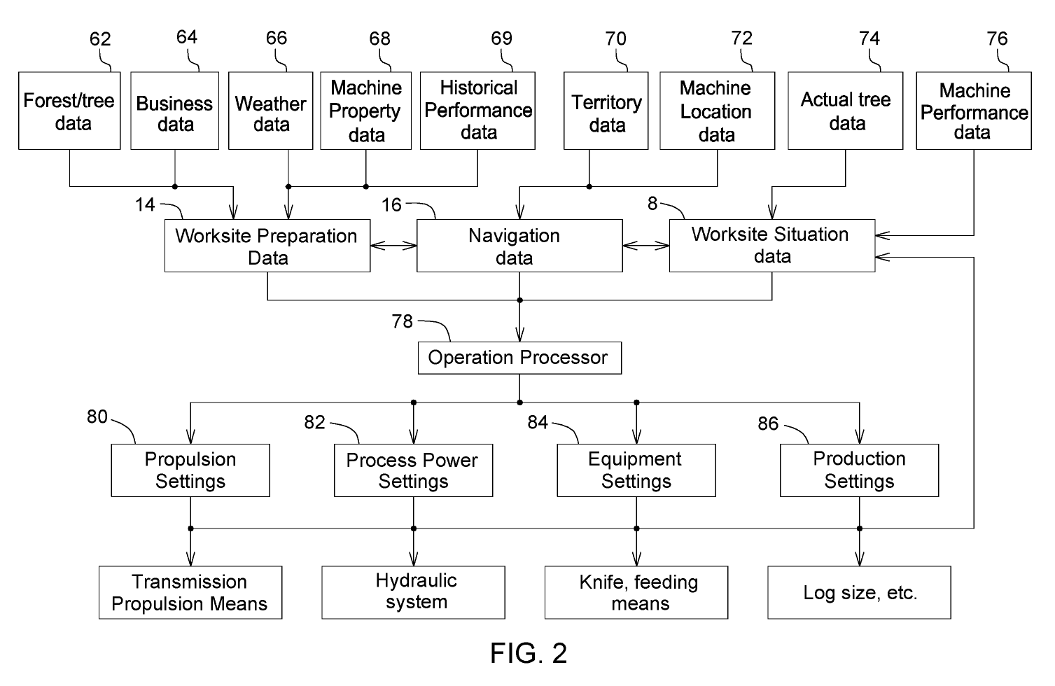

Corresponding reference numerals are used to indicate corresponding parts throughout the several views.

### DETAILED DESCRIPTION

The embodiments of the present disclosure described below are not intended to be exhaustive or to limit the disclosure to the precise forms disclosed in the following detailed description. Rather, the embodiments are chosen and described so that others skilled in the art may appreciate and understand the principles and practices of the present disclosure.

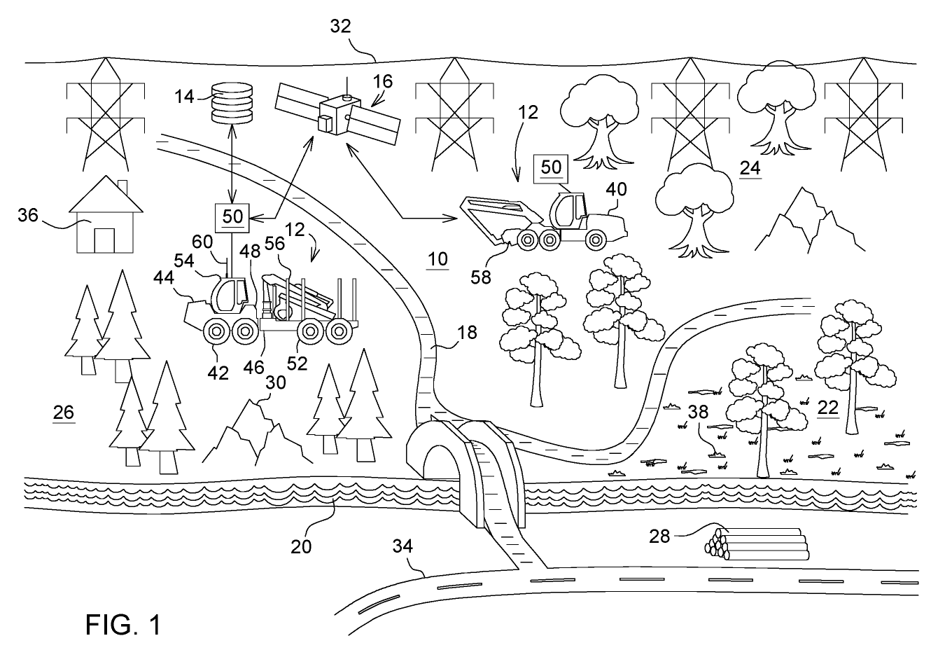

FIG. 1 shows a worksite 10 at which different forestry machines 12 are operating using worksite preparation data 14, navigation data 16 and worksite situation data 8.

A typical worksite 10 is located in or close to a forest and has paths 18, creeks 20, areas 22, 24, 26 of trees of different species, landing places 28, rocks 30, power lines 32, streets 34, buildings 36, swampland 38, just to name a few. The worksite 10 may vary in size and is usually indexed in the navigation data 16 with most of its content, characteristics, borders, etc.

Forestry machines 12 may be any kind of harvester 40 (Cut-to-Length as well as Full-Tree), forwarder 42, skidder, etc. In addition to forestry machines, dozers, stump removers, planters, etc. may also be used. The forest machines 12 may be equipped with an engine 44, a drive assembly 46, a hydraulic assembly 48, an electronic control unit 50 to operate the main components, which may be propulsion means 52 like wheels and axles, a cab 54, a boom 56, a harvesting unit 58 and the like. These types of forestry machines 12 are known per se.

The worksite preparation data 14 are available in the form of a database with information helpful to operate the forestry machines 12, i.e., individually or as a fleet. The data helps making decisions and adjustments of the forestry machines 12 or the composition of the fleet before, but also during, operation. The worksite preparation data 14 may be located remote from the worksite 10 and are continuously updated with new information. The information may be provided to the forestry machines 12 online or by a transferable data source, like a USB stick or the like. Such data may include the following:

a) Forest data 62 such as the kind of trees (species, size, age, shape, stiffness, weight, amount, diseases, ground wetness, coverage with snow, tree deceases, tree shape, underwood, etc.) at the worksite 10, known from watching the forest like with cameras, drones, LIDAR, human beings, etc.;

b) Business Data 64, like requirements of the purchaser or owner of the trees, sale prices, traffic data, fleet data, etc.;

c) Weather data 66, like actual weather, weather forecast, conditions on the ground, etc.;

d) Machine property data 68, like the horsepower range, lift capacity, equipment such as one or two saws, multi tree grapple or not, etc.; and

e) Historical performance data 69 from earlier machines, which may help setting and choosing forestry machines 12, for example, at similar worksites 10.

The navigation data 16 may include territory data 70, like the borders of the worksite 10, the course of the paths 18, creeks 20 and power lines 32, the location of the rocks 30 and buildings 36, as well as the landing places 28, swampland 38, the tree areas 22 to 26 and soil data. The navigation data 16 may include location data 72 about the current location and potentially past location of the forestry machines 12 or logs. Navigation data 16 may be aggregated data of current and previous worksite operations. The navigation data 16 is helpful in steering the forestry machines 12 to, at and from the worksite 10, whereas the forestry machines 12 are provided with antennas 60 in order to receive and send location data 72. Navigation data may comprise measurements (e.g., CAN) and sensing results (e.g., imaging, LIDAR etc.) from any machine visiting the same location. This information accumulates during operation. Information is shared between machines and is updated with increased resolution and precision due to higher number of visiting times and sensors. Navigation data is common near real-time and kept up-to-date during operation.

The worksite situation data 8 may include data which is not collected in advance but is captured during operation. This may include actual tree data 74 and machine performance data 76. Actual tree data 74 may be bends, strong branches, rotten portions, and the like detected by a camera. Machine data may include hydraulic pressure, inclination, speed, temperature, fuel consumption, steering angle, etc. Worksite situation data 8 may also come from the whole log logistics chain, e.g., if a log truck is delayed or other bottlenecks in a chain could activate a mode to save fuel. So, the whole logging chain real-time parametrization may happen at the same moment. Individual machine real-time adaptation and optimization is based on various information sources enabling adaptation and optimization computing of output signals in one or more machine processors. Sources can be, for example, navigation data, machine performance, operation conditions, operation environment, production and productivity. During operation at the worksite 10, gathered and processed worksite situation data 8 can be shared among other forestry machines 12. Once shared, worksite situation data 8 and resulting processed outputs become available as common navigation data 16 and machine performance optimization data acting as sources for other forestry machines 12. All data may be used to influence the operation of the forest machine 12 in order to reduce fuel consumption, achieve a higher output of log, prevent damages at the knives, etc.

The worksite preparation data 14, navigation data 16 and worksite situation data 8 are the input to an operation processor 78. The operation processor 78 uses this data to run one or more routines to create output signals to valves, switches, controls etc. for adjusting propulsion settings 80 like transmission gear, speed, deceleration, etc., to process power settings 82 like lift capacity of a boom, saw speed, feed wheel speed, etc., to equipment settings 84 like the use of lower knives, use of a top saw, knife pressure, etc., and to production settings 86 like log length. The operation processor 78 may be provided physically on any of the forestry machines 12 as well as in the cloud or a connected server. These routines execute the forestry machinery operation method. These settings have an impact on fuel consumption, machine output, wear on the components, etc., and may be optimized as such or altogether. The operation processor 78 is part of an electronic control 50 disposed in an onboard computer.

As worksite preparation data and navigation data are available before operation starts, the configuration of the forestry machine 12 and the selection of the right one may happen pre-operation, whereas worksite situation data 8 will be used during operation.

The following are some examples of control through the operation processor 78. Adjustments may happen, for example, at:

a) the engine 44, where different power-torque lines may be followed depending on the circumstances expected, like hard wood treatment vs. bulk wood;

b) the propulsion means 52, where minimum and maximum pressures in the hydraulic drives may be set depending on certain operation circumstances, like loading or driving a forwarder 42, etc.;

c) the choice of the equipment, e.g., forwarders 42 with a small loading capacity may be used in swampland 38, whereas those with a big load space are planned for more dry and level areas.

Also, harvesters 40 with top and bottom saw may be directed to tree areas with trees having many bends. Harvesters 40 having a multi-tree or bio-energy equipment on their harvester unit 58 may be directed to certain tree areas 22-26 if needed.

Control of the forestry machines 12 happens via their electronic control unit 50 located in the cab 54 or elsewhere, whereas the electronic control units 50 of several forestry machines 12 may connect to each other to build a network such that the operation processor 78 is part of the electronic control unit 50. The control of the forestry machines 12 may happen remotely from a control station, directly by an operator on the forestry machine 12 itself, or as a combination thereof. Here, an advanced adjustment may happen remotely, whereas fine-tuning may be made by a local operator depending on the circumstances.

While the various data are shown in individual boxes, it is also clear that this is only one example to classify them. However, there is a constant exchange and update of data in the boxes by data and information in the other boxes, like between the worksite preparation data 14, the navigation data 16 and the worksite situation data 8.

Based on the description above, the following are examples of improved machine operation due to the application of the forestry machinery operation method.

In one example, a worksite preparation phase, collected image-data shows that the worksite 10 to be started includes mostly big trees with thick branches. Automatically, the settings of the harvester 40 starting to cut that site will be set to the highest power model, in which the engine 44 has a high torque. Similarly, if the trees were small and with thin branches, the settings would be set accordingly to use less power. This is an impact on process power settings 82.

In another example, a harvester 40 grabs a stem and through image processing it is noticed that although the tree diameter is small, there are some thick branches on it. Hence, the processing power level will be set to level “high” for that specific stem to ensure smooth processing of that stem, and returned back to normal level after that stem. This is also an impact on process power settings 82.

In a further example, a harvester 40 grabs a stem and after fell-cut starts to feed it. The bucking instructions, combined with the estimated stem profile, predicts that three saw logs may be received from that stem with a length of 5.2 m each, and this will be indicated to the operator through an operation user interface. However, image data processing recognizes that there is a bad bend at the stem at the height of 9 m and stem part between 9.0 and 9.4 m is not valid for saw log quality requirements. Based on this information, the bucking is changed and two saw logs with lengths of 4.6 and 4.3 m are proposed to be cut before the bent part of the stem. This is an impact on production settings 86.

In yet a further example, a forwarder 42 on a worksite has a load space full of logs and starts to drive towards the landing place 28 next to the street 34 along certain paths 18 through the worksite 10. Measurement data from the forwarder 42 indicates that the load of the engine 44 at a certain part of that path 18 or street 34 will be high and the driving conditions may be difficult. Before reaching that location, adaptive driveline control settings will be switched to a high level to ensure there is enough power to go through that difficult part of the path 18 or street 34 efficiently. Similarly, if conditions are known to be easy, the settings of the drive assembly may be set to an Eco Mode with better fuel economy for easy conditions. This is an impact on propulsion settings 80.

If the above settings are made by an operator, they may be reactive only to the conditions already found. Through the automatic forestry machinery operation method described, the settings of the forestry machine 12 may be adjusted to the situation proactively.

While exemplary embodiments incorporating the principles of the present disclosure have been disclosed hereinabove, the present disclosure is not limited to the disclosed embodiments. Instead, this application is intended to cover any variations, uses, or adaptations of the disclosure using its general principles. Further, this application is intended to cover such departures from the present disclosure as come within known or customary practice in the art to which this disclosure pertains and which fall within the limits of the appended claims.

1. A method for operating forestry machinery, comprising:
providing timber units with forestry machines and an operation processor;
detecting or receiving data from an information source, the data including worksite preparation data, navigation data, or worksite situation data;
processing the data by the operation processor;
setting operation parameters of the forestry machine based on the processing step; and
communicating instructions to the forestry machine by the operation processor, where the instructions include the operation parameters.

2. The method of claim 1, wherein, during a harvesting operation, the worksite preparation data comprises at least one of assortment data of the worksite, assortment deviation data of the worksite, GIS-data, and weather forecast data.

3. The method of claim 1, wherein, during a transporting operation, the worksite preparation data comprises at least one of current production inventory status data on the worksite, GIS-data, weather forecast data, and data from other vehicles on the worksite.

4. The method of claim 1, wherein the operation processor detects or receives navigation data comprising at least one of location, heading, inclination, terrain, tree and timber unit location data.

5. The method of claim 1, wherein the operation processor detects or receives worksite situation data comprising at least one of surrounding timber data, ground condition and weather data.

6. The method of claim 1, further comprising providing at least one of a sensor, an onboard camera, or other imaging system for performing the detecting step.

7. The method of claim 1, wherein the setting step comprises optimizing by the operation processor at least one of minimum fuel consumption, minimum wear on selected tools, maximum timber unit quality, and maximum productivity.

8. The method of claim 1, wherein the operation processor receives worksite preparation data comprising the size, hardness and species of a tree to be harvested.

9. The method of claim 1, further comprising generating by the operation processor power setting signals suitable to handle trees according to an expected performance level.

10. The method of claim 1, further comprising:
determining from the worksite situation data an irregular power need;
sending a signal to process power settings generated by the operation processor; and
handling trees in accordance with a performance level based on the irregular power need.

11. The method of claim 1, further comprising:
determining by the operation processor from the worksite situation data an irregular shaped tree capable of impacting process quality or quantity; and
sending a signal to a production setting unit by the operation processor, where the signal is suitable for processing the irregular shaped tree.

12. The method of claim 1, further comprising:
determining by the operation processor from worksite situation data a load for moving logs over a terrain;
receiving information from the navigation data or another forestry machine on the worksite indicative of a rise in transportation power need at a certain portion of a route over the terrain; and
sending a signal to a propulsion setting generated by the operation processor suitable to generate sufficient transport power before arriving at the portion of the route.

13. A forestry system for performing a forestry operation, comprising:
at least one forestry machine having an engine, a drive assembly, an electronic control unit for operating the machine, a boom, and a harvesting unit;
a sensor for detecting data comprising worksite preparation data, navigation data, or worksite situation data; and
an operation processor disposed in electrical communication with the sensor and configured to receive the data, the operation processor comprising a processor for executing a set of instructions to output signals to control the machine for performing the forestry operation.

14. The system of claim 13, wherein the at least one forestry machine comprises a plurality of settings including propulsion settings, power settings, equipment settings, and production settings.

15. The system of claim 13, wherein the operation processor forms part of the electronic control unit on the machine.

16. A method for operating forestry machinery, comprising:
providing timber units with forestry machines and an operation processor;
detecting or receiving data from an information source, the data including worksite preparation data, navigation data, or worksite situation data;
processing the data by the operation processor;
setting operation parameters of the forestry machine based on the processing step;
communicating instructions to the forestry machine by the operation processor, where the instructions include the operation parameters; and
optimizing by the operation processor at least one of minimum fuel consumption, minimum wear on selected tools, maximum timber unit quality, and maximum productivity.

17. The method of claim 16, further comprising generating by the operation processor power setting signals suitable to handle trees according to an expected performance level.

18. The method of claim 16, further comprising:
determining from the worksite situation data an irregular power need;
sending a signal to process power settings generated by the operation processor; and
handling trees in accordance with a performance level based on the irregular power need.

19. The method of claim 16, further comprising:
determining by the operation processor from the worksite situation data an irregular shaped tree capable of impacting process quality or quantity; and
sending a signal to a production setting unit by the operation processor, where the signal is suitable for processing the irregular shaped tree.

20. The method of claim 16, further comprising:
determining by the operation processor from worksite situation data a load for moving logs over a terrain;
receiving information from the navigation data or another forestry machine on the worksite indicative of a rise in transportation power need at a certain portion of a route over the terrain; and
sending a signal to a propulsion setting generated by the operation processor suitable to generate sufficient transport power before arriving at the portion of the route.
